(19) United States
(12) Patent Application Publication
(10) Pub. No.: US 2014/0333247 A1
(43) Pub. Date: Nov. 13, 2014

(54) REDUCED TORQUE RIPPLE SYSTEM

(71) Applicant: Seagate Technology LLC, Cupertino, CA (US)

(72) Inventor: John Freeman, Longmont, CO (US)

(73) Assignee: Seagate Technology LLC, Cupertino, CA (US)

(21) Appl. No.: 13/892,157

(22) Filed: May 10, 2013

(51) Int. Cl. H02P 6/10

(52) U.S. Cl. CPC H02P 6/10
USPC 318/503

(57) ABSTRACT

An apparatus with reduced torque ripple is disclosed. The apparatus includes a back electromotive force (BEMF) detector, a harmonic identifier, and a compensator circuit. The BEMF detector is configured to detect a BEMF voltage waveform. The harmonic identifier is configured to receive the BEMF voltage waveform and is further configured to identify at least one harmonic contributing to a torque ripple. The compensator circuit is configured to compensate for the at least one harmonic to reduce the torque ripple.

### BACKGROUND

In magnetic recording media, as used in hard disk storage devices, information is written to and read from magnetic elements that represent digital bits. Often, prominent discrete tones are generated, thereby degrading quality and system performance. Prominent discrete tones may result from torque ripple at certain frequencies that ride on the torque required to rotate the disk in the disk drive. Torque ripple may result from geometric dimensions of the spindle motor, magnetic flux characteristics within the motor, and the current wave shape of the driver electronic, to name a few.

Attempts have been made to reduce torque ripple, thereby reducing prominent discrete tones. For example, attempts have been made to design electronic drive system to generate sinusoidal waveforms to reduce torque ripple. Some have attempted to modify the sinusoidal shape of the waveforms to reduce torque ripple while others have used a constant power system to maintain power to the motor at a constant level in order to provide some measure of harmonic cancellation.

### SUMMARY

An apparatus with reduced torque ripple is disclosed. The apparatus includes a back electromotive force (BEMF) detector, a harmonic identifier, and a compensator circuit. The BEMF detector is configured to detect a BEMF voltage waveform. The harmonic identifier is configured to receive the BEMF voltage waveform and is further configured to identify at least one harmonic contributing to a torque ripple. The compensator circuit is configured to compensate for the at least one harmonic to reduce the torque ripple.

These and various other features and advantages will be apparent from a reading of the following detailed description.

### BRIEF DESCRIPTION OF DRAWINGS

Embodiments of the present invention are illustrated by way of example, and not by way of limitation, in the figures of the accompanying drawings and in which like reference numerals refer to similar elements.

FIGS. 1A and 1B illustrate a system for reducing torque ripple according to one aspect of the present embodiments.

FIG. 2 illustrates a harmonic detector unit according to one aspect of the present embodiments.

FIGS. 3A-3C illustrate compensator circuit and graphical representation of the signals according to one aspect of the present embodiments.

FIGS. 4A and 4B illustrate flow diagrams for reducing torque ripple according to one aspect of the present embodiments.

FIG. 5 illustrates a diagram of a hard drive with reduced torque ripple according to one aspect of the present embodiments.

### DETAILED DESCRIPTION

Reference will now be made in detail to embodiments, examples of which are illustrated in the accompanying drawings. While the embodiments will be described in conjunction with the drawings, it should be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

Prominent discrete tones may lead to quality degradation and a decrease in performance. As discussed, prominent discrete tones may result from torque ripple at certain frequencies that ride on the torque required to rotate the disk in the disk drive. Major contributors to torque ripple are geometric dimensions of the spindle motor, e.g., stator and magnet assembly, magnetic flux characteristics within the motor, current wave shape of the driver electronic, back electromotive force (BEMF) waveform harmonic content, driver current waveform harmonic content, etc.

Attempts have been made to reduce torque ripple, thereby reducing prominent discrete tones. BEMF may represent the torque in the system. Accordingly, detecting the BEMF can be used to detect the amount of torque ripple in the system in order to reduce it. Most attempts to detect BEMF use zero crossing windows, which introduce additional torque ripple into the system. Embodiments described herein continuously monitor BEMF waveform, without using the zero crossing windows, to generate drive voltage of the motor for canceling certain BEMF harmonics that contribute to the torque ripple.

According to embodiments herein, once the BEMF is detected, harmonics of interest that contribute the most to the torque ripple are identified. It is appreciated that in one embodiment, one may choose to reduce the torque ripple resulting from the harmonic that contributes the most while in another embodiment one may choose to reduce the torque ripple resulting from two harmonics that contribute the most. It is also appreciated that one may choose to reduce the torque ripple resulting from any of a number of the harmonics regardless of whether they contribute the most, the least, or somewhere in between the most and the least to the torque ripple.

Once the harmonics of interest are identified, the harmonics of interest may be generated using the detected BEMF. The generated harmonics of interest may be removed from the original BEMF in order to generate the compensated BEMF waveform with reduced torque ripple.

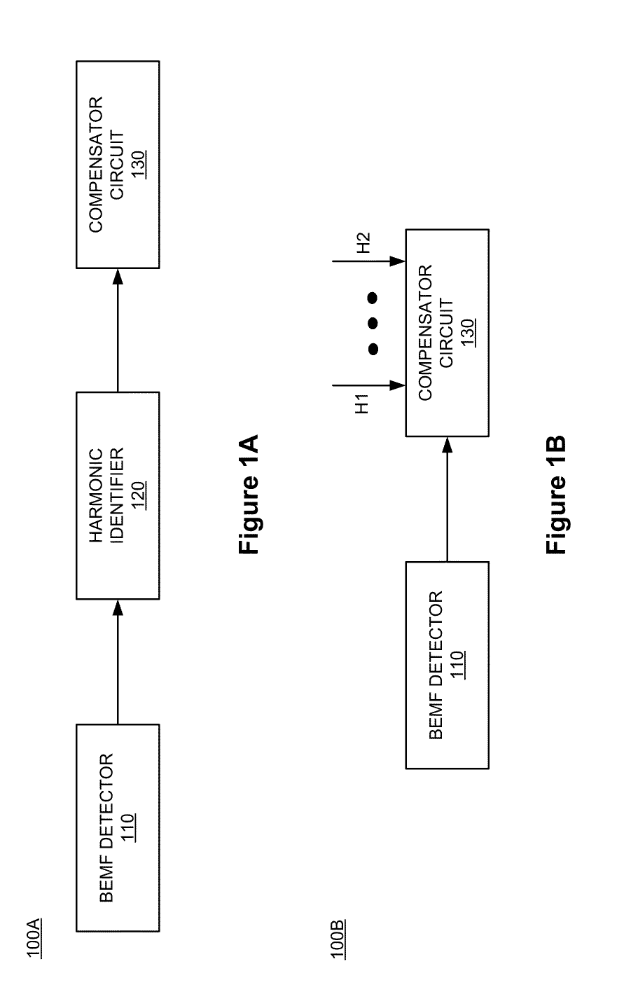

Referring now to FIGS. 1A and 1B, a system for reducing torque ripple according to one aspect of the present embodiments is illustrated. System 100A includes a BEMF detector 110, a harmonic identifier 120, and a compensator circuit 130.

The BEMF detector 110 is configured to detect the BEMF waveform that represents the ripple torque. According to one embodiment, the BEMF is detected without using zero crossing windows. For example, a total voltage applied to motor's coil may be found with respect to resistive network centertap and driver's circuit output. The resistive loss voltage dropped across the motor's coil may be found by measuring the current through the sense resistor. To find the voltage drop, the measured current through the sense resistor may be scaled by the coil's resistance and divided by the sense resistor's resistance. Finally the BEMF may be detected by determining the difference between the total voltage and the resistive loss voltage.

The harmonic identifier 120 is configured to identify the harmonics of interest. For example, the harmonics of interest in the BEMF waveform may be harmonics that contribute the most to the ripple torque. In the examples that will follow it is presumed that the fifth and the seventh harmonics are two harmonics that contribute the most to the torque ripple. However, it is appreciated that embodiments described are not limited thereto and any harmonic regardless of whether it contributes the most, the least, or somewhere in between the most and the least to the ripple torque may be identified and subsequently reduced.

The compensator circuit 130 is configured to generate the identified harmonics. For example, the fifth and the seventh harmonics of the BEMF are generated. Subsequently, the compensator circuit 130 may remove the generated harmonics of the BEMF from the BEMF, thereby compensating for the harmonics that contribute to the torque ripple. It is appreciated that removing harmonics is referred to herein as reducing its impact on the BEMF waveform. It is appreciated that the compensated BEMF may be stored in a memory component of the motor such that each time the motor is turned on, the compensated BEMF is used to drive the motor, thereby reducing the ripple torque. Furthermore, it is appreciated that this method may be employed for each disk drive, therefore customizing the compensating BEMF regardless of the variation in the manufacturing process, components, etc.

System 100B includes the BEMF detector unit 110 and the compensator circuit 130. It is appreciated that the components in system 100B function similar to that of system 100A. However, in this embodiment, the harmonics of interest are not identified as in 100A by harmonic identifier 120, but are rather provided to the compensator circuit 130. For example, the compensator circuit 130 may receive user input signals identifying that harmonics of interest are H1, . . . , H2.

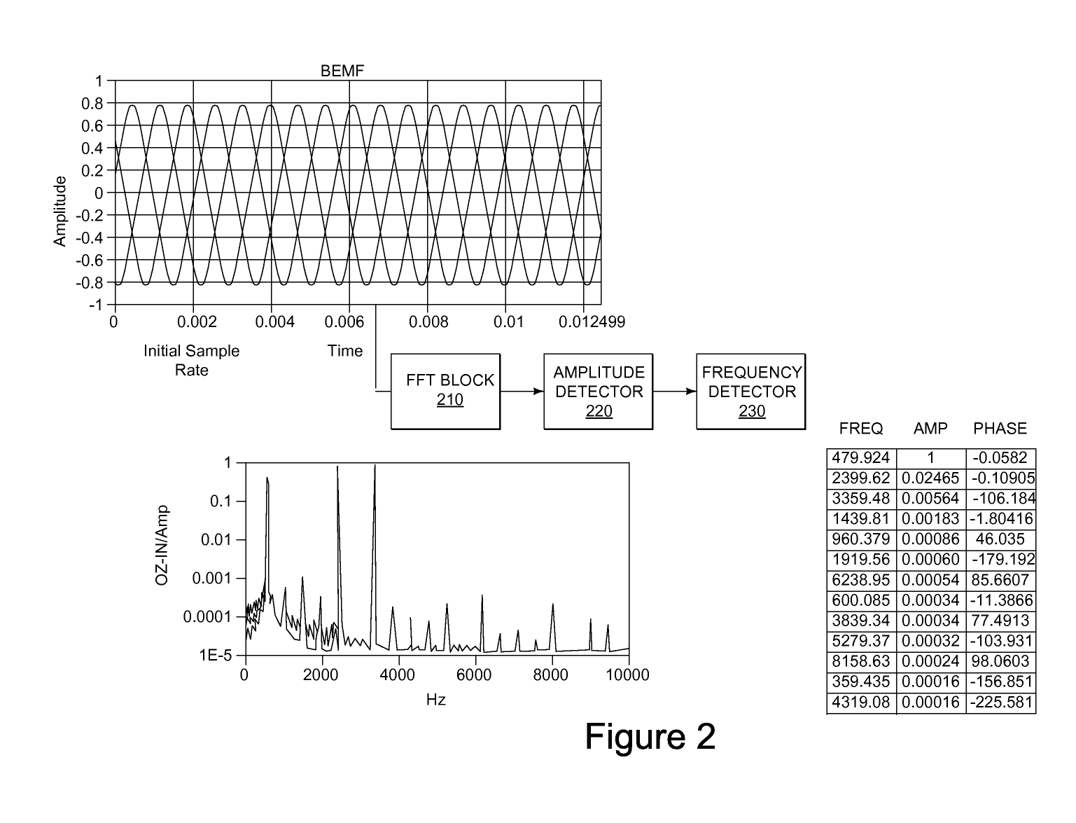

Referring now to FIG. 2, a harmonic detector unit according to one aspect of the present embodiments is illustrated. The harmonic detector unit may include a Fast Fourier Transform (FFT) block 210, an amplitude detector 220, and a frequency detector 230. It is appreciated that the phase may also be detected (not shown). According to one embodiment, the harmonic detector unit may be a spectrum analyzer.

The FFT block 210 may receive the detected BEMF waveform. Performing an FFT on the BEMF waveform transforms the BEMF waveform in the frequency domain and illustrates the frequencies at which the harmonics occur and it also illustrates their strength, i.e., amplitude. In other words, each peak in the frequency domain, other than the highest peak, corresponds to a harmonic within the BEMF waveform. The highest peak corresponds to the motor torque and not the harmonics of the BEMF. Amplitude of each peak represents the strength of each harmonic within the BEMF.

The amplitude detector block 220 detects the amplitudes associated with each harmonic of the BEMF. For example, a first harmonic has an amplitude close to unity whereas the second, third, fourth, fifth, sixth and the seventh harmonics are 0.00086, 0.00183, 0.00060, 0.02485, approximately 0, and 0.00564 respectively. The frequency detector block 230 detects the frequencies associated with each harmonic, e.g., as shown in the table of FIG. 2. It is appreciated that the phase may similarly be detected (not shown).

The harmonic detector unit may therefore be used to identify the harmonics that contribute the most to the torque ripple and subsequently be removed. In this example, the top two harmonics contributing to the torque ripple are the fifth and the seventh harmonic with their respective amplitudes of 0.02485, and 0.00564. As such, the top two harmonics of the BEMF may be removed and/or compensated for. However, it is appreciated that any number of harmonics may be removed and compensated for and illustration of removing the fifth and the seventh harmonic in this example are merely examples and not intended to limit the scope of the embodiments.

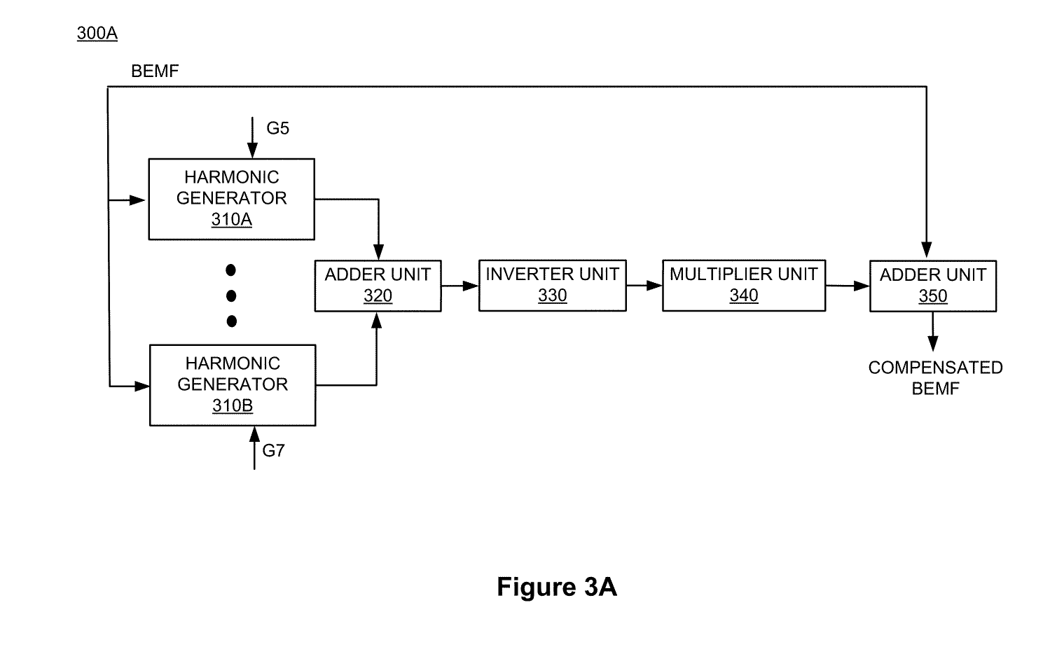

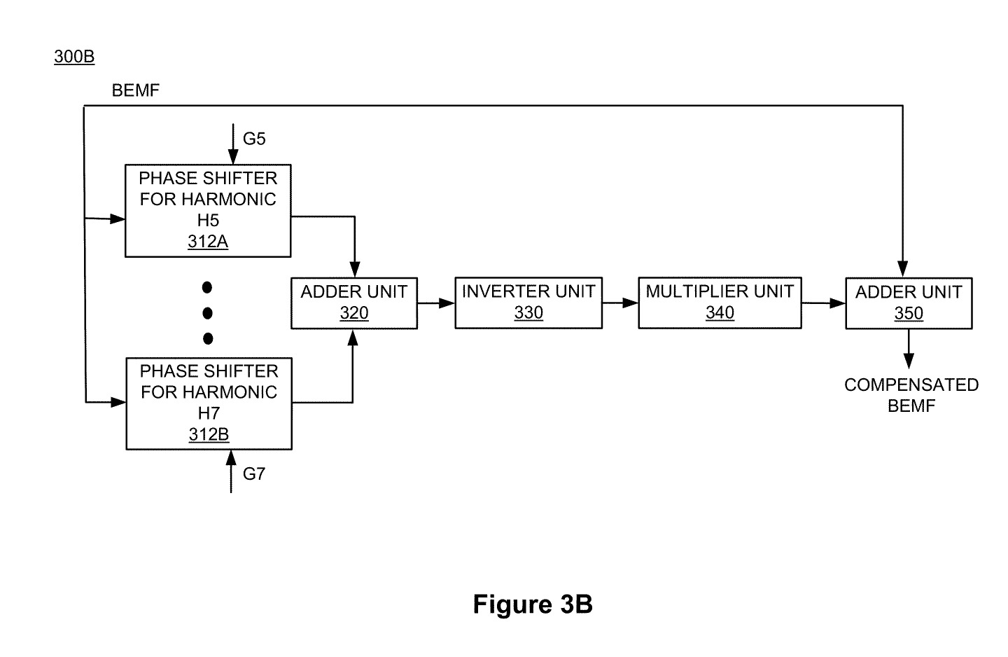

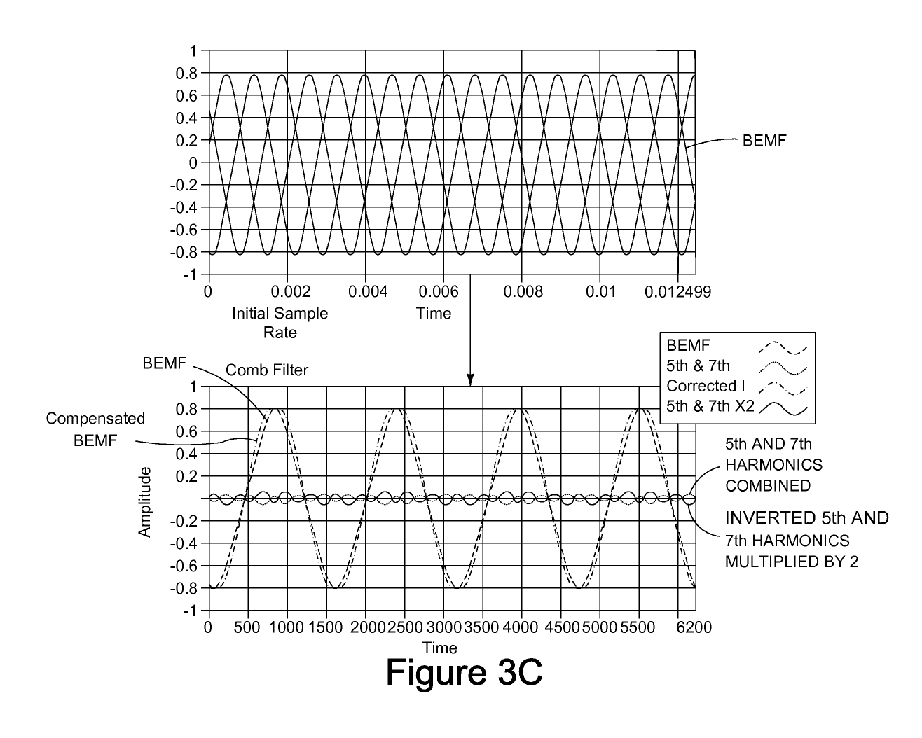

Referring to FIG. 3A-3C compensator circuit and graphical representation of the signals according to one aspect of the present embodiments is illustrated. System 300A includes harmonic generators 310A through 310B, a first adder unit 320, an inverter unit 330, a multiplier unit 340, and a second adder unit 350.

Harmonic generators 310A through 310B receive BEMF waveform as well as signals G5 and G7 indicating that fifth and the seventh harmonics are to be generated. It is appreciated that generation of the fifth and the seventh harmonics are merely examples and not intended to limit the scope of the embodiments. In this example, it is chosen to reduce the torque ripple effects based on the top two harmonics contributors.

According to one embodiment, the generated harmonics are combined using the first adder unit 320. In order to remove the harmonics of interest from the BEMF, the combined harmonics, i.e., fifth and the seventh harmonics, are inverted using the inverter 330. In one embodiment, the inverter may be a phase shifter that phase shifts the combined harmonics by 180 degrees.

The amplitude of the inverted harmonics may be adjusted by a factor of two in order to properly compensate for the harmonics in the BEMF waveform using the multiplier 340. The result may then be removed from the BEMF using the adder unit 350. Accordingly, the output of the adder unit 350 is the compensated BEMF.

In one embodiment, the compensated BEMF may be stored in a memory component of the disk drive. As such, at each startup the compensated BEMF may be used, thereby reducing the torque ripple.

System 300B is similar to that of 300A except that the harmonic generator units are replaced with harmonic phase shifters 312A through 312B. The harmonic phase shifter receives the BEMF as well as the identified harmonic of interest, e.g., fifth and seventh harmonic. The harmonic phase shifter 312A shifts the BEMF by one fifth each time until the fifth harmonic is generated. Similarly, the harmonic phase shifter 312B shifts the BEMF by one seventh each time until the seventh harmonic is generated. The generated harmonics are used to generate the compensated BEMF that is subsequently stored in the memory component of the disk drive. FIG. 3C shows the waveforms at each step for illustration purposes.

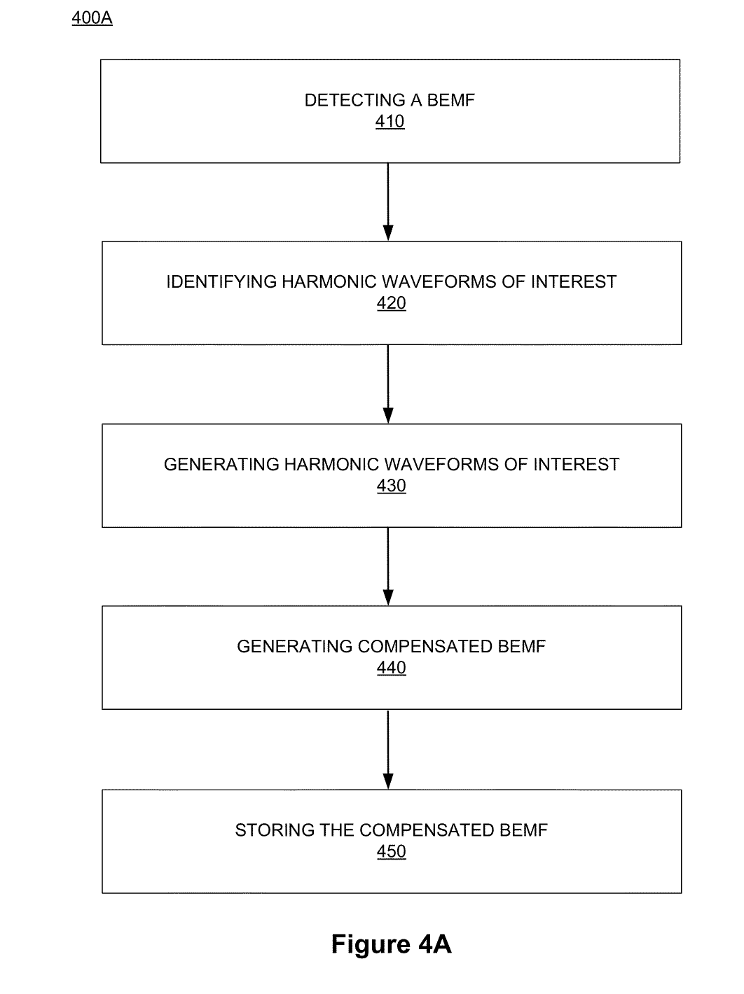

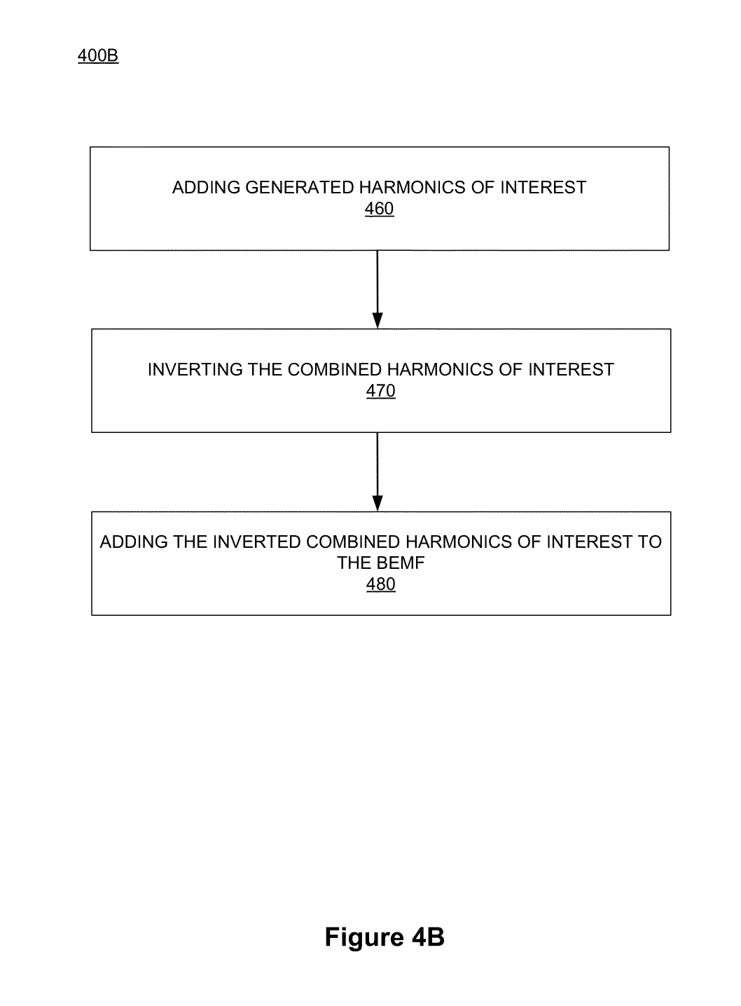

Referring now to FIGS. 4A and 4B flow diagrams for reducing torque ripple according to one aspect of the present embodiments are shown. At step 410, BEMF voltage waveform associated with a disk drive is detected. As discussed, the BEMF represents the torque ripple in the system. According to one embodiment, the BEMF is detected without using zero crossing windows.

At step 420, harmonics of interest are identified. For example, as discussed above a spectrum analyzer may identify the top two harmonics contributing to the torque ripple to be the fifth and the seventh harmonic of the BEMF. Once the BEMF harmonics of interest are identified, the BEMF harmonics of interest are generated at step 430 such that they can get compensated for. At step 440, the BEMF is used along with the generated harmonics of interest in order to remove them from the BEMF to generate the compensated BEMF.

At step 450, the compensated BEMF waveform may be stored in a memory component of the disk drive. As such, at every startup the compensated BEMF waveform may be used to drive the disk drive, thereby reducing the torque ripple.

Referring now to FIG. 4B, flow 400B for generating the compensated BEMF in accordance with one embodiment is shown. At step 460, harmonics of interest, e.g., the fifth and the seventh harmonics of the BEMF, are combined. At step 470, the combined harmonics, hence added harmonic waveforms, are inverted. According to one embodiment, the combined harmonics may be inverted by phase shifting the combined harmonics waveform by 180 degrees. In one embodiment, the inverted combined harmonics may be doubled in magnitude to appropriately compensate for the harmonics within the BEMF and in order to remove from the BEMF waveform (not shown). At step 480, the inverted combined harmonics may be removed from the BEMF by adding them to the BEMF voltage waveform. As such, the compensated BEMF waveform is created.

Thus, the harmonics of interest that contribute the most and that are responsible for the torque ripples in a disk drive can be removed. The compensated BEMF waveform may be stored in a memory component of a disk drive such that each time that the disk drive becomes operational it utilizes the compensated BEMF with reduced torque ripple.

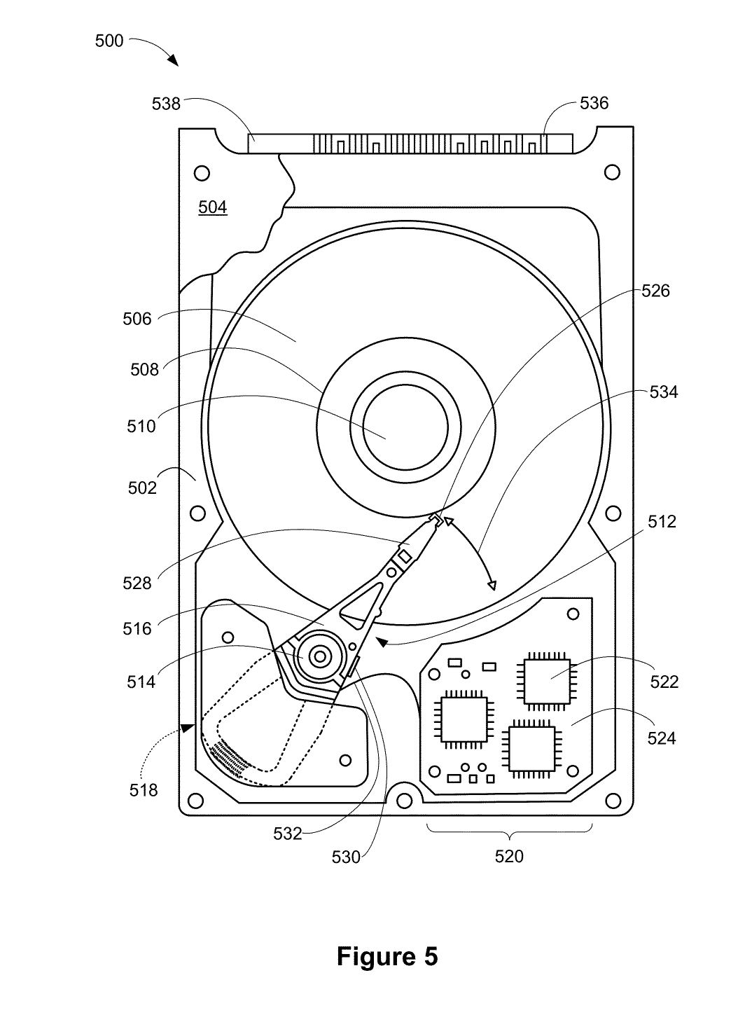

Referring now to FIG. 5, a plan view of a data storage device with reduced torque ripple in which embodiments as described in FIGS. 1-6 may be implemented in is shown. A disk drive 500 generally includes a base plate 502 and a cover 504 that may be disposed on the base plate 502 to define an enclosed housing for various disk drive components. The disk drive 500 includes one or more data storage disks 506 of computer-readable data storage media. Typically, both of the major surfaces of each data storage disk 506 include a plurality of concentrically disposed tracks for data storage purposes. Each data storage disk 506 is mounted on a hub 508, which in turn is rotatably interconnected with the base plate 502 and/or cover 504. Multiple data storage disks 506 are typically mounted in vertically spaced and parallel relation on the hub 508. A spindle motor 510 rotates the data storage disks 506.

The disk drive 500 also includes an actuator arm assembly 512 that pivots about a pivot bearing 514, which in turn is rotatably supported by the base plate 502 and/or cover 504. The actuator arm assembly 512 includes one or more individual rigid actuator arms 516 that extend out from near the pivot bearing 514. Multiple actuator arms 516 are typically disposed in vertically spaced relation, with one actuator arm 516 being provided for each major data storage surface of each data storage disk 506 of the disk drive 500. Other types of actuator arm assembly configurations could be utilized as well, an example being an “E” block having one or more rigid actuator arm tips, or the like, that cantilever from a common structure. Movement of the actuator arm assembly 512 is provided by an actuator arm drive assembly, such as a voice coil motor 518 or the like. The voice coil motor 518 is a magnetic assembly that controls the operation of the actuator arm assembly 512 under the direction of control electronics 520.

The control electronics 520 may include a plurality of integrated circuits 522 coupled to a printed circuit board 524. The control electronics 520 may be coupled to the voice coil motor assembly 518, a slider 526, or the spindle motor 510 using interconnects that can include pins, cables, or wires (not shown).

A load beam or suspension 528 is attached to the free end of each actuator arm 516 and cantilevers therefrom. Typically, the suspension 528 is biased generally toward its corresponding data storage disk 506 by a spring-like force. The slider 526 is disposed at or near the free end of each suspension 528. What is commonly referred to as the read/write head (e.g., transducer) is appropriately mounted as a head unit (not shown) under the slider 526 and is used in disk drive read/write operations. The head unit under the slider 526 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 526 is connected to a preamplifier 530, which is interconnected with the control electronics 520 of the disk drive 500 by a flex cable 532 that is typically mounted on the actuator arm assembly 512. Signals are exchanged between the head unit and its corresponding data storage disk 506 for disk drive read/write operations. In this regard, the voice coil motor 518 is utilized to pivot the actuator arm assembly 512 to simultaneously move the slider 526 along a path 534 and across the corresponding data storage disk 506 to position the head unit at the appropriate position on the data storage disk 506 for disk drive read/write operations.

When the disk drive 500 is not in operation, the actuator arm assembly 512 is pivoted to a “parked position” to dispose each slider 526 generally at or beyond a perimeter of its corresponding data storage disk 506, but in any case in vertically spaced relation to its corresponding data storage disk 506. In this regard, the disk drive 500 includes a ramp assembly (not shown) that is disposed beyond a perimeter of the data storage disk 506 to both move the corresponding slider 526 vertically away from its corresponding data storage disk 506 and to also exert somewhat of a retaining force on the actuator arm assembly 512.

Exposed contacts 536 of a drive connector 538 along a side end of the disk drive 500 may be used to provide connectivity between circuitry of the disk drive 500 and a next level of integration such as an interposer, a circuit board, a cable connector, or an electronic assembly. The drive connector 538 may include jumpers (not shown) or switches (not shown) that may be used to configure the disk drive 500 for user specific features or configurations. The jumpers or switches may be recessed and exposed from within the drive connector 538.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The implementations described above and other implementations are within the scope of the following claims.

What is claimed is:

1. An apparatus comprising:
a back electromotive force (BEMF) detector configured to detect a BEMF voltage waveform;
a harmonic identifier configured to receive the BEMF voltage waveform, and wherein the harmonic identifier is configured to identify at least one harmonic contributing to a torque ripple; and
a compensator circuit configured to compensate for the at least one harmonic to reduce the torque ripple.

2. The apparatus of claim 1, wherein the harmonic identifier is configured to perform a fast fourier transform (FFT) on the BEMF voltage waveform, and wherein a higher amplitude resulting from the FFT contributes more to the torque ripple in comparison to a lower amplitude resulting from the FFT.

3. The apparatus of claim 2, wherein peaks of the FFT of the BEMF voltage waveform correspond to harmonics of the BEMF voltage waveform.

4. The apparatus of claim 1, wherein the harmonic identifier is a spectrum analyzer.

5. The apparatus of claim 1, wherein the compensator circuit comprises a comb filter.

6. The apparatus of claim 1, wherein the compensator circuit is configured to generate the at least one harmonic and remove the at least one harmonic from the BEMF voltage waveform to generate a compensated BEMF.

7. The apparatus of claim 6 further comprising a memory component of a disk drive configured to store the compensated BEMF, wherein the compensated BEMF is used to make a motor operational.

8. The apparatus of claim 1, wherein the harmonic identifier is configured to identify two harmonics that contribute the most to the torque ripple, and wherein the compensator circuit is configured to generate the two harmonics from the BEMF voltage waveform, and wherein the compensator circuit is configured to add the two harmonics and is further configured to remove the added harmonics from the BEMF voltage waveform to generate a compensated BEMF.

9. A device comprising:
a back electromotive force (BEMF) detector configured to detect a BEMF voltage waveform of a disk drive; and
a compensator circuit configured to compensate for at least one harmonic associated with the BEMF voltage waveform to reduce a torque ripple of the disk drive.

10. The device of claim 9, wherein the at least one harmonic is a fifth and seventh harmonic associated with the BEMF voltage waveform.

11. The device of claim 9, wherein the compensator circuit comprises a comb filter.

12. The device of claim 9, wherein the compensator circuit is configured to generate the at least one harmonic and remove the at least one harmonic from the BEMF voltage waveform to generate a compensated BEMF.

13. The device of claim 12 further comprising a memory component within the disk drive configured to store the compensated BEMF, wherein the compensated BEMF is used to make a motor of the disk drive operational.

14. The device of claim 9, wherein the compensator circuit comprises a phase shifter associated with each harmonic of the at least one harmonic, an adder unit, and an inverter unit, wherein the phase shifter is configured to generate the harmonic associated therewith, and wherein the adder unit is configured to combine the generated harmonics to generate the combined harmonics, and wherein the inverter unit is configured to invert the combined harmonics, and wherein the compensator circuit further comprises an adder unit for adding the inverted combined harmonics from the BEMF voltage waveform to generate a compensated BEMF.

15. A method comprising:
detecting a back electromotive force (BEMF) voltage waveform of a disk drive;
generating two harmonic waveforms, wherein amplitudes the two harmonic waveforms are to be reduced in the BEMF voltage waveform; and
generating a compensated BEMF voltage waveform based on the BEMF voltage waveform and the two harmonic waveforms, wherein the compensated BEMF voltage waveform compensates for the two harmonic waveforms associated with the BEMF voltage waveform to reduce a torque ripple of the disk drive.

16. The method of claim 15 further comprising:
identifying the two harmonic waveforms prior to the generating the two harmonic waveforms, wherein the identifying identifies harmonics that contribute the most to the torque ripple of the disk drive.

17. The method of claim 15 further comprising:
adding the two harmonic waveforms to form a combined harmonics;
inverting the combined harmonic to form an inverted waveform; and
adding the inverted waveform to the BEMF voltage waveform to form the compensated BEMF voltage waveform.

18. The method of claim 15 further comprising:
storing the compensated BEMF voltage waveform in a memory component of the disk drive.

19. The method of claim 15, wherein the two harmonic waveforms are a fifth and a seventh harmonic of the BEMF voltage waveform.

20. The method of claim 15, wherein the generation of the two harmonic waveforms includes phase shifting the BEMF voltage waveform.
